(19) United States
(12) Patent Application Publication
(10) Pub. No.: US 2013/0320898 A1
(43) Pub. Date: Dec. 5, 2013

(54) MEANS AND METHOD FOR ALIGNING HALL SENSORS LOCATION IN A BRUSHLESS DC MOTOR WITH HALL SENSORS

(71) Applicant: DURQ MACHINERY CORP., TAICHUNG (TW)

(72) Inventors: Chii-Maw UANG, KAOHSIUNG CITY (TW); Zu-Sheng HO, KAOHSIUNG CITY (TW)

(73) Assignee: DURQ MACHINERY CORP., TAICHUNG (TW)

(21) Appl. No.: 13/750,484

(22) Filed: Jan. 25, 2013

(30) Foreign Application Priority Data
May 30, 2012 (TW) 101119431
May 30, 2012 (TW) 101210393

(51) Int. Cl. H02P 31/00

(52) U.S. Cl. CPC H02P 31/00
USPC 318/400.38

(57) ABSTRACT

A method for aligning Hall sensors location in a brushless DC motor with Hall sensors, the method comprises driving the motor by a sensorless driving system for getting a first commutation phase signal; sending said first commutation phase signal to a sensorless position control unit to be processed thereby for getting an optimal commutation phase point, processing a Hall sensor signal as said motor is running by a Hall sensor circuit unit for getting a second commutation phase signal, and comparing said second commutation phase signal with said optimal commutation phase point by a signal comparing and processing unit to get a phase shifting data for aligning said Hall sensors location.

### BACKGROUND OF THE INVENTION

1. Field of the Invention

The present invention is related to brushless DC motors, and more particularly to a means and method for aligning Hall sensors location in a brushless DC motor with Hall sensors.

2. Description of the Related Art

It is well known that brushless DC motor drives commonly use Hall sensors to determine rotor position. For there are many potential sources of error, such as the relative mechanical locations of the Hall sensor and the magnet, the resolution and accuracy of the sensor, the pole width of the sense magnet, and the physical relationship between the sense magnet and the rotor, the position measured by the Hall sensors may not exactly match the real rotor position. This position error can cause generation of lower torque at a given current. Thus, one of the most important needs in this art is to determine an alignment error of a Hall sensor and then optimize the location of the Hall sensor.

Conventional technique to match the need mentioned above generally uses an outside pulling mechanism to drive a brushless DC motor running at a predetermined speed to detect alignment errors of a Hall sensor, and then proceeds the aligning work according to such detected errors. This prior art technique has some problems. For example, one of the problems is that it is difficult, complicate and time consuming to couple the outside pulling mechanism with the brushless DC motor to be detected. The other one, a most important one, is that for working done by man, the precision of the last result of the prior art technique is unsatisfied.

### SUMMARY OF THE INVENTION

In order to improve the preceding problems, an object of the present invention is to provide a method and means capable of simply, easily and precisely aligning Hall sensors location in a brushless DC motor with Hall sensors.

Accordingly, a method for aligning Hall sensors location in a brushless DC motor with Hall sensors comprises the following steps: driving the motor by a sensorless driving system for getting a first commutation phase signal; sending said first commutation phase signal to a sensorless position control unit to be processed thereby for getting an optimal commutation phase point; processing a Hall sensor signal as said motor is running by a Hall sensor circuit unit for getting a second commutation phase signal; and comparing said second commutation phase signal with said optimal commutation phase point by a signal comparing and processing unit to get a phase shifting data for aligning said Hall sensors location.

A means for proceeding the method mentioned above comprises a micro controller unit (MCU) which includes a sensorless position control unit and a signal comparing and processing unit connected thereto. The means further comprises a sensorless driving system connected between said motor and said sensorless position control unit of said MCU to drive said motor and send a first commutation phase signal as said motor is running to said sensorless position control unit of said MCU to get an optimal commutation phase point being sent to said signal comparing and processing unit. The means further comprises a Hall sensor circuit unit connected between said Hall sensors of said motor and said signal comparing and processing unit of said MCU for receiving and processing the Hall sensor signals sent from said Hall sensors to get a second commutation phase signal being sent to said signal comparing and processing unit of said MCU for being compared with said optimal commutation phase point thereby to get a phase shifting data for aligning said Hall sensors location.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a circuit diagram of a first embodiment of the present invention illustrating a method and means for aligning Hall sensors location in a brushless DC motor with Hall sensors; and

FIG. 2 is a graph illustrating wave curve of output signals of the first embodiment according to the present invention shown in FIG. 1.

### DETAILED DESCRIPTION OF THE INVENTION

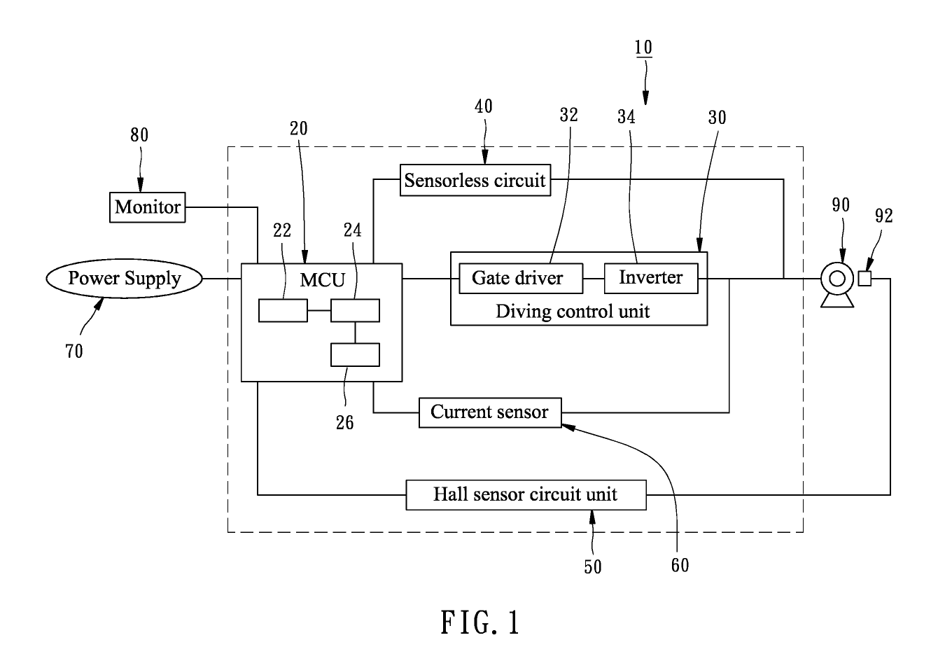

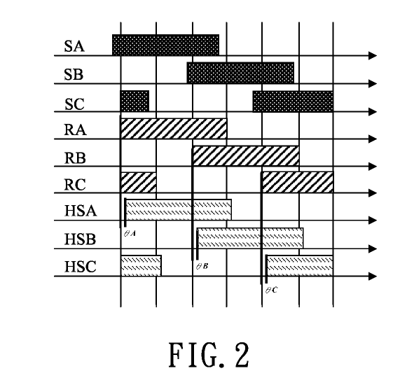

Referring to FIGS. 1 and 2, a method and means embodied according to the present invention are illustrated in the same time by a circuit 10.

The circuit 10 is connected with a 3 phase brushless DC motor 90 with a set of Hall Sensors 92 disposed thereon, a power supply 70 and a monitor 80. The circuit 10 includes a micro controller unit (MCU) 20, a driving control unit 30, a sensorless circuit 40, a Hall sensor circuit unit 50, and a current sensor 60.

The MCU 20, in the embodiment herein, includes a signal processing unit 22, a sensorless position control unit 24 and a signal comparing and processing unit 26. The sensorless position control unit 24 had been disclosed in IEEE-PEDS in December 2011 (The document is enclosed as Annex 1).

The driving control unit 30 includes a gate driver 32 and a inverter 34. The gate driver 32 has input ends connected to the MCU 20 and output ends connected to input ends of the inverter 34. The inverter 34 has output ends connected to the motor 90.

The sensorless circuit 40 has first ends connected to the motor 90 and second ends connected to the signal processing unit 22 of the MCU 20.

The Hall sensor circuit unit 50 has input ends connected to the Hall sensors 92 and output ends connected to the sensorless position control unit 26 of the MCU 20.

In this embodiment, the sensorless driving system is composed by the sensorless circuit 40 to detect the position signal of the rotor of the motor, the signal processing unit 22 to receive and process the position signal for getting a drive signal and the driving control unit 30 to receive the drive signal for driving the motor 90.

The circuit 10 further includes a current sensor 60 having first ends connected to the motor 90 and second ends connected to the sensorless position control unit 24 of the MCU 20. When the motor 90 is running, the current sensor 60 will sent a current signal to the sensorless position control unit 24.

In operating, the method is firstly to drive the motor 90 by the sensorless driving system. When the motor 90 is running at a rating speed, a first commutation phase signal SA, SB and SC (as shown in FIG. 2) detected by the signal processing unit 22 will be send to the sensorless position control unit 24. In this embodiment, the sensorless position control unit 24, as disclosed in Annex 1, will process the first commutation phase signal SA, SB and SC and the current signal sent from the current sensor 60 for getting an optimal commutation phase point RA, RB and RC (as shown in FIG. 2).

As the motor runs at the rating speed, the Hall sensor 92 will send a signal to the Hall sensor circuit unit 50 for getting a second commutation phase signal HAS, HSB and HSC (as shown in FIG. 2). And then the second commutation phase signal HAS, HSB and HSC will be send to the signal comparing and processing unit 26 to be compared with the optimal commutation phase point to get a phase shifting data θA, θB and θC (as shown in FIG. 2) for aligning the location of the Hall sensor 92. All of the signals mentioned above will be monitored from the monitor 80.

Annex 1: the article disclosed in IEEE-PEDS in December 2011

1. A method for aligning a Hall sensor location in a brushless DC Motor with Hall sensors, comprising the following steps:
driving the motor by a sensorless driving system for getting a first commutation phase signal;
sending said first commutation phase signal to a sensorless position control unit to be processed thereby for getting an optimal commutation phase point;
processing a Hall sensor signal sent from the Hall sensor as said motor is running by a Hall sensor circuit unit for getting a second commutation phase signal; and
comparing said second commutation phase signal with said optimal commutation phase point by a signal comparing and processing unit to get a phase shifting data for aligning said Hall sensors location.

2. The method of claim 1, wherein said sensorless driving system comprises a sensorless circuit to detect the position signal of the rotor of the motor; a signal processing unit connected to said sensorless circuit to receive and process the position signal for getting a drive signal; and a driving control unit connected between said motor and said signal processing unit to receive said drive signal for driving said motor.

3. The method of claim 1, wherein signal processing unit, said sensorless position control unit and said signal comparing and processing unit are disposed in a micro controller unit (MCU).

4. The method of claim 3 further comprising:
getting a current signal as said motor is running by a current sensor connected between said MCU and the motor;
sending said current signal to said sensorless position control unit to be processed thereby to get said optimal commutation phase point.

5. A means for proceeding the method of claim 1, comprising:
a micro controller unit (MCU) which includes a sensorless position control unit and a signal comparing and processing unit;
a sensorless driving system connected between said motor and said sensorless position control unit of said MCU to drive said motor and send a first commutation phase signal as said motor is running to said sensorless position control unit of said MCU to get an optimal commutation phase point; and
a Hall sensor circuit unit connected between said Hall sensors of said motor and said signal comparing and processing unit of said MCU for receiving and processing the Hall sensor signals sent from said Hall sensors to get a second commutation phase signal and send it to said signal comparing and processing unit of said MCU to be compared with said optimal commutation phase point thereby to get a phase shifting data for aligning said Hall sensors location.

6. The means of claim 5, wherein said sensorless driving system comprises:
a sensorless circuit to detect the position signal of the rotor of the motor;
a signal processing unit connected to said sensorless circuit to receive and process the position signal for getting a drive signal; and
a driving control unit connected between said motor and said signal processing unit to receive said drive signal for driving said motor.

7. The means of claim 6, wherein said signal processing unit is disposed on said MCU.

8. The means of claim 5, further comprising a current sensor connected between said motor and said MCU.
